(19) United States
(12) Patent Application Publication
(10) Pub. No.: US 2005/0219424 A1
(43) Pub. Date: Oct. 6, 2005

(54) Digital tuner control apparatus and control method

(75) Inventor: Hoi Ryu, Tachikawa-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHBIA, Tokyo (JP)

(21) Appl. No.: 11/048,784

(22) Filed: Feb. 3, 2005

(30) Foreign Application Priority Data
Mar. 31, 2004 (JP) 2004-108111

(51) Int. Cl. H04N 5/44

(52) U.S. Cl. 348/734; 348/554

(57) ABSTRACT

This invention allows an analog broadcasting remote controller to control a digital tuner in addition to an original digital tuner remote controller. A remote-control signal processor in the digital tuner receives a transmission signal from the analog broadcasting remote controller, selects one of a terrestrial digital broadcasting reception state, BS broadcasting reception state, and CS broadcasting reception state and selects one of media in each reception state, and displays an icon corresponding to the selected broadcasting reception state on the screen.

### CROSS-REFERENCE TO RELATED APPLICATIONS

This application is based upon and claims the benefit of priority from prior Japanese Patent Application No. 2004-108111, filed Mar. 31, 2004, the entire contents of which are incorporated herein by reference.

### BACKGROUND OF THE INVENTION

1. Field

Embodiments of the present invention relate to a digital tuner control apparatus and control method, which can easily remote-control a digital tuner that receives radio waves in digital broadcasting.

2. Description of the Related Art

Digital tuners that receive radio waves in digital broadcasting have been developed and are on the market. In addition, in general homes, conventional analog television receivers are used. Under these circumstances, a remote controller used to control a digital tuner (to be referred to as a digital tuner remote controller hereinafter) and a remote controller used to control an analog television receiver (to be referred to as an analog broadcasting remote controller hereinafter) are offered independently on the market, and these remote controllers are present in general users' homes. Jpn. Pat. Appln. KOKAI Publication No. 2001-285965 discloses such a remote controller.

General users are accustomed to using analog broadcasting remote controllers used to control analog television receivers. However, they are unaccustomed to using digital tuner remote controllers used to control recently purchased digital tuners. Especially, it takes a long time for elderly persons until they are accustomed to a digital tuner remote controller. Hence, such users are reluctant to purchase digital tuners.

### BRIEF DESCRIPTION OF THE SEVERAL VIEWS OF THE DRAWING

The accompanying drawings, which are incorporated in and constitute a part of the specification, illustrate embodiments of the invention, and together with the detailed description of the embodiments given below, serve to explain the principles of the invention.

FIG. 1 is an exemplary view of a digital tuner remote controller according to an embodiment of the present invention;

FIG. 2 is an exemplary view of an analog broadcasting remote controller according to an embodiment of the present invention;

FIG. 3 is an exemplary view showing the relationship among a television receiver, a digital tuner, and the analog broadcasting remote controller according to an embodiment of the present invention;

FIGS. 4A and 4B are exemplary views showing icons on a screen upon operation of an apparatus according to an embodiment of the present invention;

FIGS. 5A, 5B, and 5C are exemplary views showing icons on the screen upon operation of the apparatus according to an embodiment of the present invention;

FIGS. 6A, 6B, and 6C are exemplary views showing icons on the screen upon operation of the apparatus according to an embodiment of the present invention;

FIG. 7 is an exemplary view of a block diagram showing the arrangement of principal part of a digital tuner according to an embodiment of the present invention;

FIG. 8 is an exemplary flowchart of the operation of principal part of the digital tuner according to the embodiment of the present invention;

FIG. 9 is an exemplary view showing classified functions of principal part of the digital tuner according to the embodiment of the present invention; and

FIG. 10 is an exemplary block diagram showing the arrangement of a digital tuner according to an embodiment of the present invention.

### DETAILED DESCRIPTION

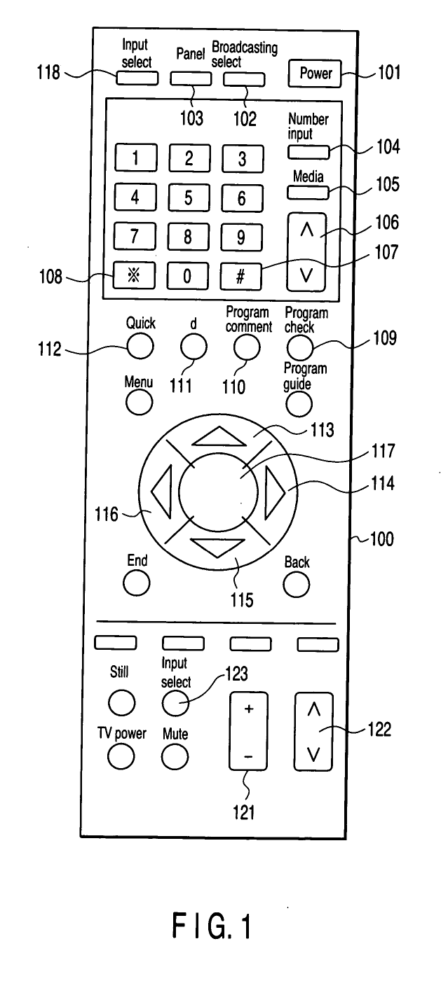

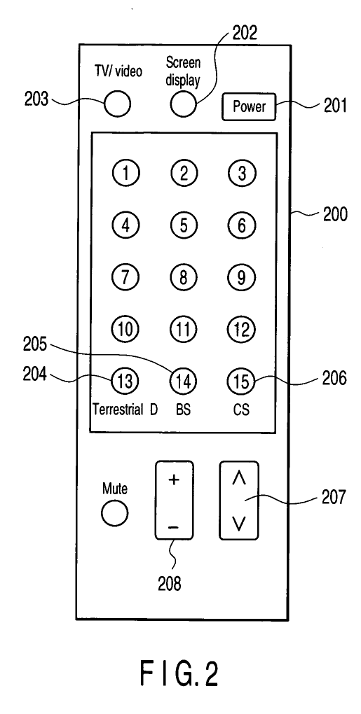

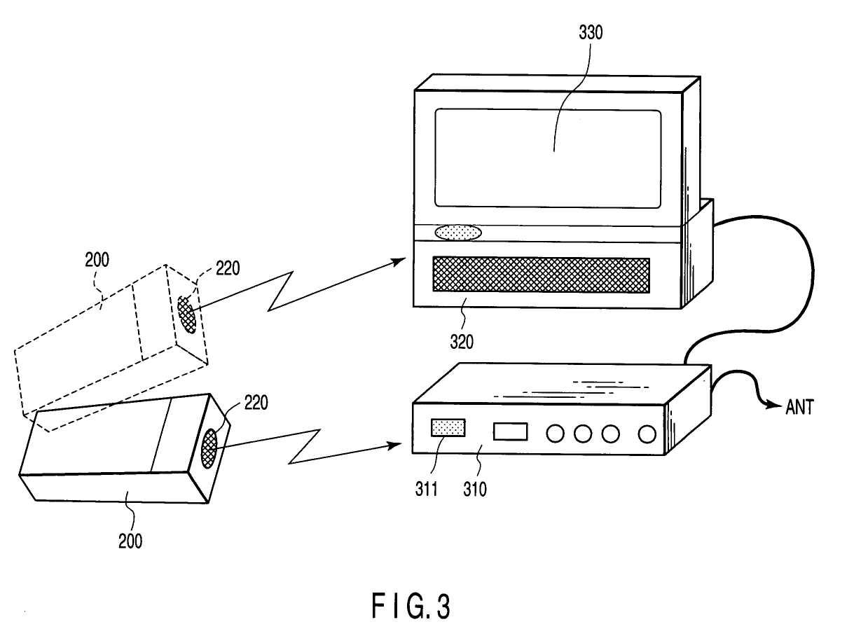

Preferred embodiments of the present invention will be described hereinafter with reference to the accompanying drawings. FIG. 1 shows an exemplary overview of a digital tuner remote controller used to control a digital tuner according to one embodiment of the invention, and FIG. 2 shows an overview of an analog broadcasting remote controller used to control an analog television receiver. FIG. 3 schematically depicts a state wherein the analog broadcasting remote controller is used.

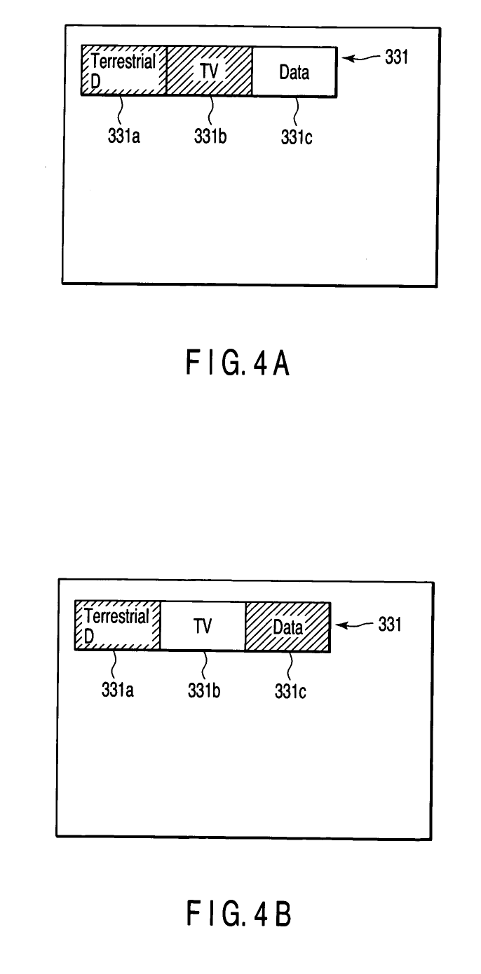

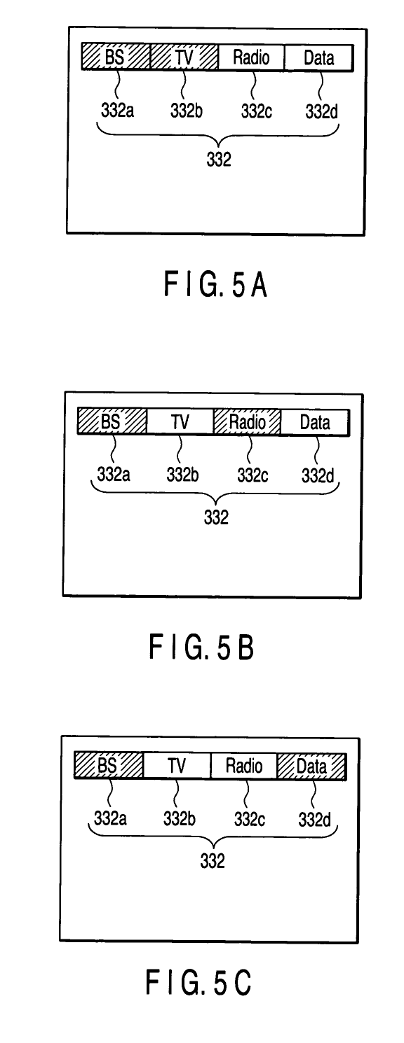

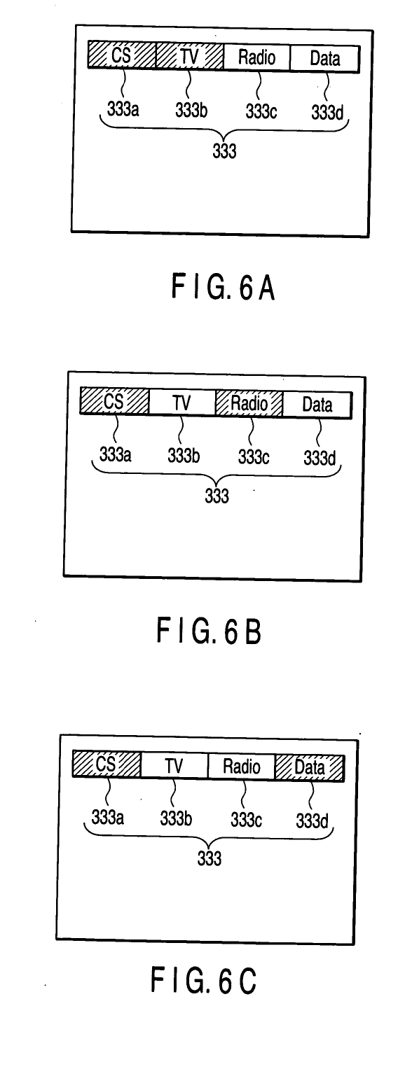

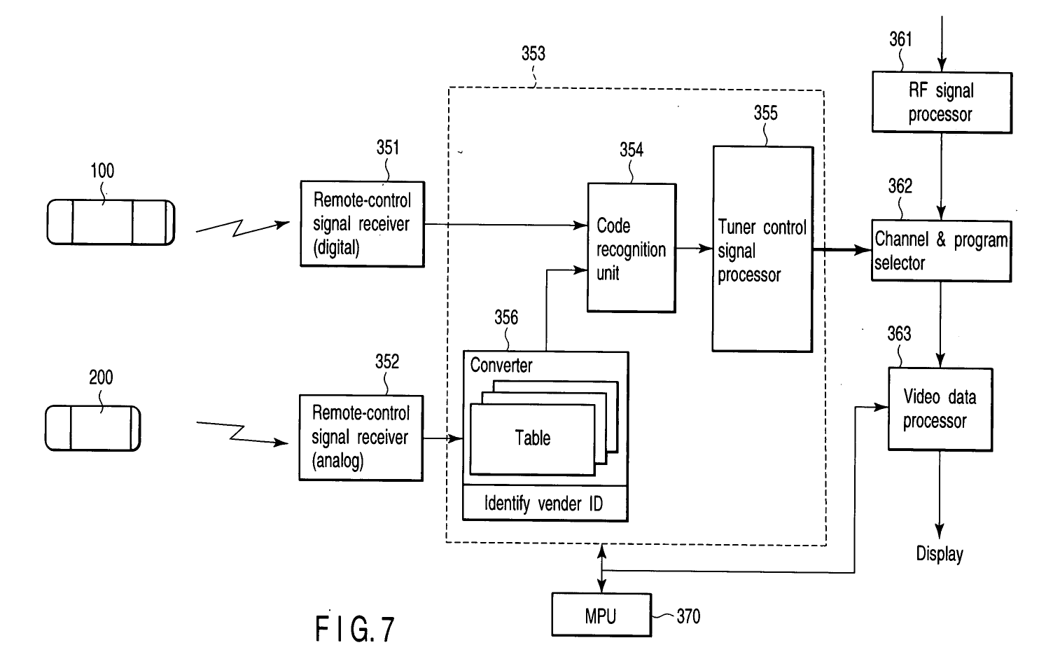

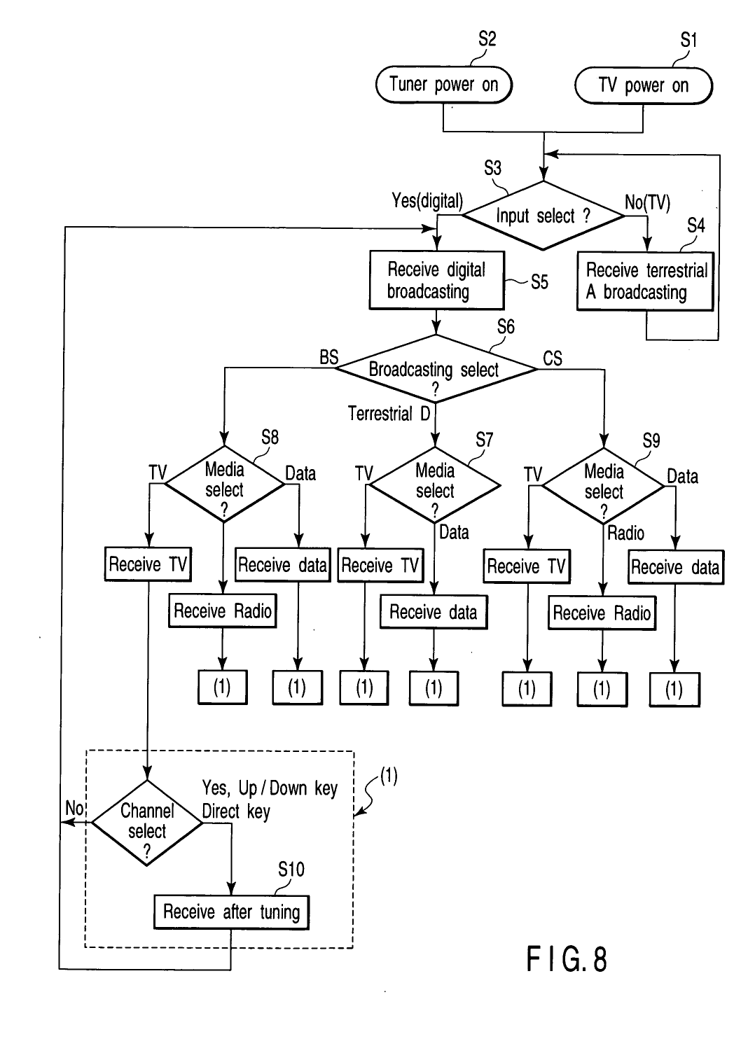

FIGS. 4A, 4B, 5A to 5C, and 6A to 6C show a state of changes in icons on the television screen when the analog broadcasting remote controller is used. FIGS. 4A and 4B show an example upon receiving terrestrial digital broadcasting, FIGS. 5A to 5C show an example upon receiving BS broadcasting, and FIGS. 6A to 6C show an example upon receiving CS broadcasting. FIG. 7 is a block diagram showing the arrangement of a remote-control signal processor in a digital tuner. FIG. 8 is a flowchart showing an example of a signal processing mode of the remote-control signal processor.

A digital tuner remote controller 100 shown in FIG. 1 will be explained below. A remote controller light-emitting unit (not shown) is provided to the front surface of the digital tuner remote controller 100. A power button 101 is an operation button used to turn on/off the digital tuner. A broadcasting select button 102 is used to switch between BS digital broadcasting and 110° CS broadcasting.

A control panel button 103 and input select button 108 are used to select and operate a device connected to the digital tuner via a link.

Numeric keys “1” to “9” and “0” are used to select a channel, and can also be used as numeric buttons. An operation button 104 is used to select a channel by designating a channel number.

A media button 105 is used for sequentially switching broadcasting media (television, radio, data). A channel button 106 is used to select a channel by incrementing/decrementing a channel number in turn.

A display button 107 is used to display information of a channel or program which is now on the air. A button 108 is used to display a favorite channel list. A program check button 109 is used to check a program which is now on air and the next program. A program comment button 110 is used to display information or a comment about a program: A data broadcasting select button 111 is used to enjoy data broadcasting: A button 112 is used to display convenient functions such as a quick menu: Furthermore, cursor buttons 113, 114, 115, and 116, an enter button 117 are used to determine a selected program.

Also, keys used to directly control a television receiver are provided to the lower portion of the digital tuner remote controller 100. A volume control button 121 is used to control a tone volume, a button 122 is used to for select a channel by incrementing/decrementing a channel number in turn; A button 123 is used to switch a video input of the television receiver. In addition, a button used to acquire a still picture, a power ON/OFF button, and a mute button are provided.

FIG. 2 shows an analog broadcasting remote controller 200. A power button 201 is used to turn on/off the power supply of the analog television receiver; A screen display button 202 is used to display channel information, program information, or the like which is now on air. An input select button 203 is used to switch a television/video input.

Numeric keys “1” to “12” are buttons used to directly select a channel. Numeric keys “13”, “14”, and “15” are, e.g., auxiliary keys. These numeric keys “13”, “14”, and “15” can be used as, e.g., a terrestrial digital broadcasting select button 204, BS broadcasting select button 205, and CS broadcasting select button 206. Note that keys to be assigned are not limited to these numeric keys, but other keys maybe assigned. Furthermore, a button 207 is used to select a channel by incrementing/decrementing a channel number. A volume control button 208 is used to control volume.

As can be seen from comparison between the remote controllers 100 and 200 shown in FIGS. 1 and 2, the arrangement of the digital tuner remote controller 100 which is manufactured exclusively for the digital tuner is considerably complicated compared to that of the analog broadcasting remote controller 200 shown in FIG. 2, and has more operation buttons.

In the embodiment of the present invention, a remote-control data processor of the digital tuner is improved, so that the digital tuner can be controlled by the simple analog broadcasting remote controller 200 shown in FIG. 2. Prior to the description of the remote-control data processor, icons which appear on the television screen upon controlling the digital tuner using the analog broadcasting remote controller 200 will be explained.

FIG. 3 shows the analog broadcasting remote controller 200, a digital tuner 310, and a television receiver 320. Upon operation of the analog broadcasting remote controller 200, a remote-control signal is output from a light-emitting unit 220 using infrared rays as media. This remote-control signal is received by a light-receiving unit 311 of the digital tuner 310. In this manner, the power supply of the digital tuner 310 can be turned on/off. Also, the analog broadcasting remote controller 200 can turn on/off the power supply of the television receiver 320, and can switch its external input. Note that the television receiver 320 has selected an input from the digital tuner 310.

Assume that the user has pressed the terrestrial digital broadcasting select button 204 as an operation button of the analog broadcasting remote controller 200. Then, an icon 331 shown in FIG. 4A appears on the display screen of the television receiver 320. This icon 331 includes an area (terrestrial D) 331a indicating terrestrial broadcasting, an area (TV) 331b indicating a television broadcasting reception state, and an area (data) 331c indicating a data broadcasting reception state. When the user has pressed the terrestrial broadcasting select button 204 first (for the first time), the areas 331a and 331b are displayed in a specific color, as shown in FIG. 4A, and a television reception state corresponds to the reception state of a channel and program which were received immediately before the power supply of the tuner was turned off. If the user has pressed the button 204 again from this state, the areas 331a and 331c of the icon 331 are displayed in a specific color, as shown in FIG. 4B. At this time, a data broadcasting reception state is selected. When the user has pressed the button 204 once again, the state shown in FIG. 4A is displayed again.

Assume that the user has pressed the BS broadcasting select button 205 as an operation button of the analog broadcasting remote controller 200. Then, an icon 332 shown in FIG. 5A appears on the display screen of the television receiver 320.

This icon 332 includes an area (BS) 332a indicating BS broadcasting, an area (TV) 332b indicating a television broadcasting reception state, an area (radio) 332c indicating a radio broadcasting reception state, and an area (data) 332d indicating a data broadcasting reception state. If the user has pressed the button 205 again from this state, the areas 332a and 332c of the icon 332 are displayed in a specific color, as shown in FIG. 5B. At this time, a radio broadcasting reception state is selected. If the user has pressed the button 205 again from this state, the areas 332a and 332d of the icon 332 are displayed in a specific color, as shown in FIG. 5C. At this time, a data broadcasting reception state is selected. When the user has pressed the button 205 once again, the state shown in FIG. 5A is displayed again.

Assume that the user has pressed the CS broadcasting select button 206 as an operation button of the analog broadcasting remote controller 200. Then, an icon 333 shown in FIG. 6A appears on the display screen of the television receiver 320.

This icon 333 includes an area (CS) 333a indicating CS broadcasting, an area (TV) 333b indicating a television broadcasting reception state, an area (radio) 333c indicating a radio broadcasting reception state, and an area (data) 333d indicating a data broadcasting reception state. If the user has pressed the button 206 again from this state, the areas 333a and 333c of the icon 333 are displayed in a specific color, as shown in FIG. 6B. At this time, a radio broadcasting reception state is selected. If the user has pressed the button 206 again from this state, the areas 333a and 333d of the icon 333 are displayed in a specific color, as shown in FIG. 6C. At this time, a data broadcasting reception state is selected. When the user has pressed the button 206 once again, the state shown in FIG. 6A is displayed again.

As described above, the apparatus of the embodiment of the present invention can control the digital tuner via the analog broadcasting remote controller.

FIG. 7 shows an exemplary view of a remote-control processor 353 included in the digital tuner 310. The digital tuner 310 has a remote-control signal receiver 351 which receives a transmission signal from the original digital tuner remote controller 100, and a remote-control signal receiver 352 for receiving a transmission signal from the analog broadcasting remote controller 200. The command contents of the remote-control signal received by the remote-control signal receiver 351 are recognized by a code recognition unit 354 that recognizes a remote-control code. This command is sent to a tuner control signal processing unit 355. Based on this command, the remote-control signal processor 353 controls a channel & program selector 362 to select a channel and program. The channel & program selector 362 receives an RF signal from an RF signal processor 361. The RF signal contains a BS, CS, or terrestrial digital broadcasting signal. A video signal selected by the channel & program selector 362 undergoes processes such as a luminance signal process, color signal process, amplification, and the like, and is then sent to a display.

On the other hand, a transmission signal from the analog broadcasting remote controller 200 is received by the remote-control signal receiver 352. Since the remote-control signal received by this remote-control signal receiver 352 cannot be directly used, it is temporarily input to a converter 356. This converter 356 can convert the input remote-control signal into a command suited to the digital tuner 310. The converted command is input to the code recognition unit 354, and is used as a command for the digital tuner.

The converter 356 has a plurality of conversion tables to support analog broadcasting remote controllers 200 of a plurality of vendors. One of these conversion tables is selected according to a vendor ID. That is, the converter 356 identifies a vendor ID sent from the analog broadcasting remote controller 200, and determines the conversion table.

An MPU (microprocessing unit) 370 systematically controls respective signal processing blocks of the digital tuner. The MPU 370 monitors the operation state of the remote-control signal processor 353, and controls a video signal processor 363 to display icons shown in FIGS. 4A and 4B, FIGS. 5A to 5C, and FIGS. 6A to 6C. Note that image data used to display icons shown in FIGS. 4A and 4B, FIGS. 5A to 5C, and FIGS. 6A to 6C may be stored in a memory (not shown) of the video signal processor 363 or in a memory (not shown) of the remote-control signal processor 353.

FIG. 8 is a flowchart showing the operation of the remote-control signal processor 353 and, especially, an operation upon reception of a transmission signal from the analog broadcasting remote controller 200.

The power supply of the television receiver 320 is turned on (the remote controller is set in the state indicated by the broken line in FIG. 3) (step S1), and the power supply of the digital tuner 310 is turned on (the remote controller is set in the state indicated by the solid line in FIG. 3) (step S2). Then, the selection state of the input select button 203 is checked (in the following operation, the remote controller is directed to the digital tuner) (step S3).

If “TV” is designated by the input select button 203, a terrestrial analog broadcasting reception state is set (step S4). If “digital” (e.g., video) is designated by the input select button 203, a digital broadcasting reception state is set (step S5). That is, a state wherein one of the buttons 204, 205, and 206 is selected (the last reception selection state upon reception of digital broadcasting before this operation) is set. If the button 204 is selected, a terrestrial digital broadcasting reception state is set (steps S6 and S7); if the button 205 is selected, a BS broadcasting reception state is set (steps S6 and S8); or if the button 206 is selected, a CS broadcasting reception state is set (steps S6 and S9).

If one of the buttons is selected to determine broadcasting to be received, a media select mode is then set. Media selection is done, as has been explained above using FIGS. 4A and 4B, FIGS. 5A to 5C, and FIGS. 6A to 6C, and a medium to be selected is determined depending on the number of times of depression of a button. If one of media, i.e., TV, radio, and data, is determined, the control enters a tuning state by means of the button 207 (step S10).

As described above, in the apparatus of the present invention, the remote-control signal processor of the digital tuner has means (remote-control signal receiver 352) for receiving a transmission signal from the analog broadcasting remote controller, and broadcasting & media switching/selection means (converter 356, code recognition unit 354, tuner control signal processor 355) for selecting one of a terrestrial digital broadcasting reception state, BS broadcasting reception state, and CS broadcasting reception state in response to a predetermined button operation on the analog broadcasting remote controller, and switching and selecting one of media in the selected broadcasting reception state. Also, the remote-control signal processor has icon control means (370, 363) for displaying an icon corresponding to one of the terrestrial digital broadcasting reception state, BS broadcasting reception state, and broadcasting reception state on the screen. As shown in FIGS. 4A and 4B, FIGS. 5A to 5C, and FIGS. 6A to 6C, the icon control unit that displays an icon on the screen includes a plurality of display areas used to identify the types of media, and the broadcasting & media switching/selection unit that controls the icon control means to shift a cursor to the plurality of display areas when the predetermined button is pressed successively.

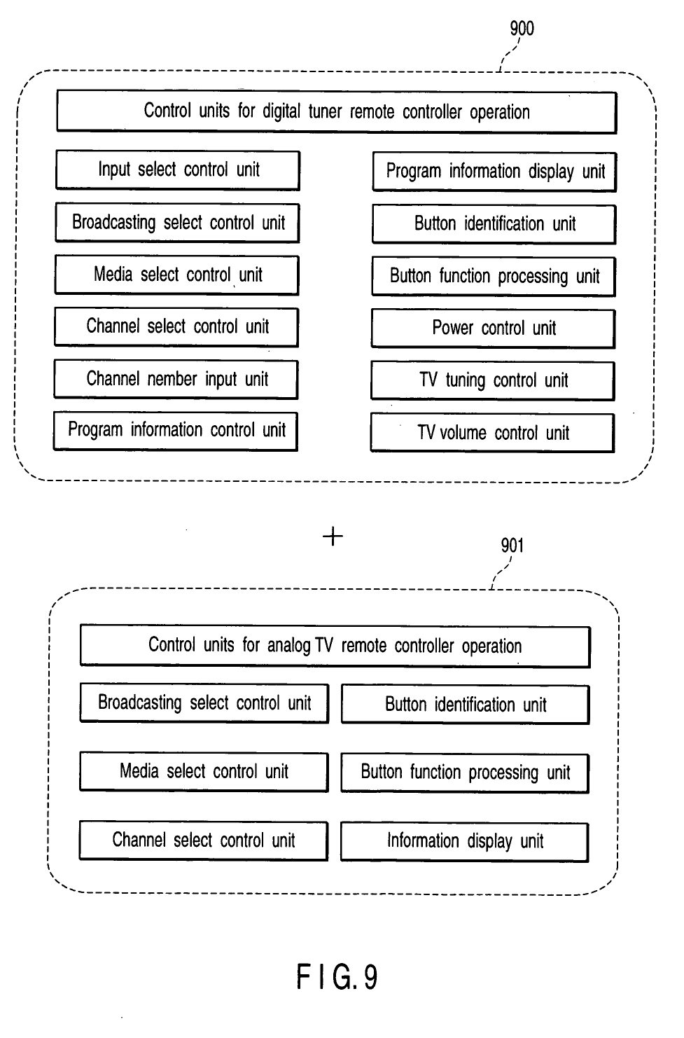

FIG. 9 shows new control functions 901 which are added to the digital tuner 310 (FIG. 3) in correspondence with the analog broadcasting remote controller 200 in addition to its original control functions 900 corresponding to the digital tuner remote controller 100 (FIG. 1). The control functions 900 include an input select control unit, broadcasting select control unit, media select control unit, channel select control unit, channel number input unit, program information display unit, button identification unit, button function processing unit, power control unit, television tuning control unit, and television volume control unit. The control functions 901 which are added to support the analog broadcasting remote controller include a broadcasting select control unit, media select control unit, channel select control unit, button identification unit, button function processing unit, and information display unit.

The “button identification unit” is registered in advance with information such as the vendor IDs of television receivers, key codes of television remote controller buttons, and the like. The “button identification unit” has a function of recognizing information sent upon operation of the remote controller of the television receiver with respect to the light-receiving unit of the tuner.

The “button function processing unit” has a function of implementing functions to be performed by the tuner in accordance with key codes that represent remote controller buttons. For example, when one of the buttons 204, 205, and 206 is pressed, one of terrestrial D broadcasting, BS broadcasting, and CS broadcasting, which are assigned to these buttons, is selected. If one of these buttons is pressed again after it is released, one of media (e.g., TV, radio, data, and the like) in each broadcasting is selected, and the last channel, which was received before power OFF, of a medium selected by the cursor, is selected. In this way, the “button function processing unit” plays a role of passing broadcasting and media select processes to respective control units.

The “broadcasting select control unit” selects one of terrestrial D broadcasting, BS broadcasting, and CS broadcasting, which are assigned to the buttons 204, 205, and 206, upon depression of one of these buttons. If one of these buttons is pressed again after it is released, one of media (e.g., TV, radio, data, and the like) in each broadcasting is selected, and the last channel, which was received before power OFF, of a medium selected by the cursor, is selected and received.

The “channel select control unit” selects a channel in turn in each of media upon depression of the “channel Up/Down” button after media selection is performed. The “information display unit” displays channel information, program information, or the like which is now on air on the television screen upon depression of the “screen display” button in the same manner as the “display” button of the tuner remote controller.

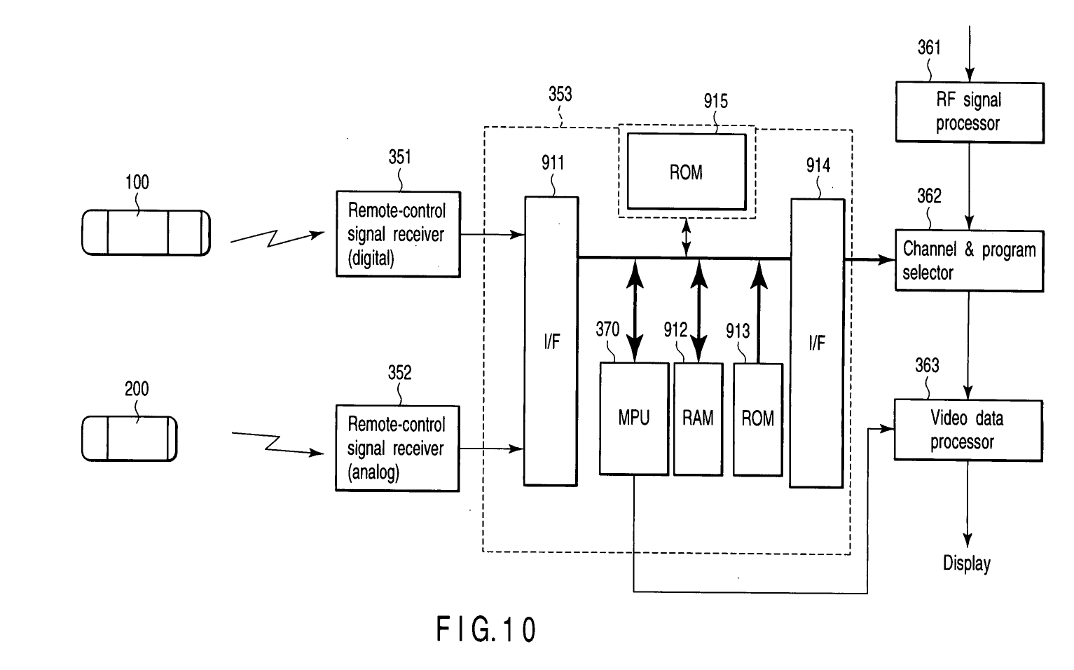

FIG. 10 shows another embodiment of the present invention. The present invention is not limited to the aforementioned embodiment. For example, the remote-control signal processor 353 may be implemented by software, and may include means for updating its functions. Referring to FIG. 10, remote-control signals from the remote-control signal receivers 351 and 352 are fetched via an interface (I/F) 911. The remote-control signals are interpreted by the MPU 370. A RAM 912 is used as a temporary data save area. A ROM 913 describes a table used to convert codes of an analog broadcasting remote controller of the same vendor as that of this digital tuner into those of the digital tuner. Also, the ROM 913 stores a basic program for controlling this digital tuner, and the operation sequence of the MPU 370 is determined by this program (e.g., the flowchart shown in FIG. 8).

A memory 915 is mounted when the program version is to be updated, or when another table used to convert codes of another analog broadcasting remote controller into those of the digital tuner is to be installed (to support a remote controller of another vendor). This memory 915 may be used to store version-up information sent via the Internet.

Note that the present invention is not limited to the aforementioned embodiments without any modification, and various modifications may be made without departing from the scope of the invention when it is practiced. Various inventions can be formed by appropriately combining a plurality of required constituent elements disclosed in the above embodiments. For example, some required constituent elements may be omitted from all the required constituent elements disclosed in the embodiments. Furthermore, the required constituent elements according to different embodiments may be combined.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

1. A digital tuner control apparatus comprising:
a digital tuner which receives digital broadcasting; and
a remote-control signal processor provided to the digital tuner,
in that the remote-control signal processor comprises:
a receiver which receives a signal transmitted from an analog broadcasting remote controller; and
a switching unit which selects a predetermined digital broadcasting reception state in response to an operation of a predetermined button provided to the analog broadcasting remote controller, and selects one of media of the selected predetermined digital broadcasting.

2. An apparatus according to claim 1, further comprising:
an icon display control unit which displays an icon corresponding to the predetermined digital broadcasting reception state on a screen,
in that the icon displayed by the icon display control unit has a plurality of display areas used to identify types of media, and
the switching unit controls the icon display control unit to select a predetermined display area from the plurality of display areas in response to the operation of the predetermined button.

3. An apparatus according to claim 2, further comprising:
a program selection unit,
in that when the broadcasting and one of media are selected, the program selection unit selects a program in each of the media in response to an operation of a button of the analog broadcasting remote controller, which is used to select a channel by incrementing/decrementing a channel number.

4. An apparatus according to claim 1, wherein the remote-control signal processor has a table switching unit which identifies a vendor ID included in a signal transmitted from the analog broadcasting remote controller, and switches a code conversion table of the remote-control signal in accordance with the identification result.

5. An apparatus according to claim 1, wherein the analog broadcasting remote controller has a screen display button, and the remote-control signal processor includes a display control unit which displays channel information and program information upon depression of the screen display button.

6. A method of controlling a digital tuner for receiving digital broadcasting, wherein a remote-control signal processor provided to the digital tuner comprises:
receiving a signal transmitted from an analog broadcasting remote controller; and
selecting a predetermined digital broadcasting reception state in response to an operation of a predetermined button provided to the analog broadcasting remote controller, and selecting one of media of the selected predetermined digital broadcasting.

7. A method according to claim 6, wherein the remote-control signal processor further comprises:
displaying an icon corresponding to the predetermined digital broadcasting reception state on a screen,
the icon displayed by displaying the icon has a plurality of display areas used to identify types of media, and
control is made to select a predetermined display area from the plurality of display areas in response to the operation of the predetermined button.

8. A method according to claim 6, wherein receiving the transmission signal includes identifying a vendor ID included in the transmission signal, and
selecting the broadcasting and one of media includes switching and selecting a table used to convert a command sent from the analog broadcasting remote controller into a command of the digital tuner in accordance with the identification result.

9. A method according to claim 8, wherein contents of the table can be externally changed.
